(19) United States
(12) Patent Application Publication
(10) Pub. No.: US 2013/0174471 A1
(43) Pub. Date: Jul. 11, 2013

(54) Rodent Bait Stations

(71) Applicants: Ethan VICKERY, Bedford, TX (US); Larry COVINGTON, Bedford, TX (US)

(72) Inventors: Ethan VICKERY, Bedford, TX (US); Larry COVINGTON, Bedford, TX (US)

(21) Appl. No.: 13/711,775

(22) Filed: Dec. 12, 2012

Related U.S. Application Data
(60) Provisional application No. 61/570,127, filed on Dec. 13, 2011.

(51) Int. Cl. A01M 25/00

(52) U.S. Cl. CPC A01M 25/004
USPC 43/131

(57) ABSTRACT

Bait stations (e.g., rodent bait stations), such as those, for example, including a J-shaped or U-shaped passage (e.g., with an open first end and a closed second end).

### CROSS-REFERENCE TO RELATED APPLICATIONS

This application claims the benefit of U.S. Provisional Patent Application No. 61/570,127 filed Dec. 13, 2011, which is incorporated by reference in its entirety.

### BACKGROUND

1. Field of the Invention

The present invention relates generally to bait stations and, more particularly, but not by way of limitation, to rodent bait stations defining an elongated channel (e.g., an elongated channel with a curved portion).

2. Brief Description of Related Art

Examples of rodent bait stations are disclosed in U.S. Pat. No. 7,735,258, and U.S. Pat. No. 7,874,098.

### SUMMARY

This disclosure includes rodent bait stations and methods of use.

Embodiments of the present bait stations comprise: a base; and a lid configured to be coupled to the base such that the base and the lid cooperate to define an elongated passage having a first end and a second end, and an entrance opening configured to permit a rodent to enter the passage; where the station is configured such that if the lid is coupled to the base in a closed configuration, bait can be disposed in the passage between the first end and the second end without being visible through the entrance opening from outside the bait station. In some embodiments, if the lid is coupled to the base in a closed configuration, the entrance opening is the only opening through which a rodent can enter the passage. In some embodiments, the entrance opening is disposed at the first end of the passage, and the base and the lid do not cooperate to define any other openings between the first end and the second end of the passage. In some embodiments, the cross-sectional area of the passage does not vary along the length of the passage by more than fifty percent (50%) relative to the smallest cross-sectional area of the passage.

In some embodiments, at least one of the base and the lid includes a sidewall defining an external perimeter of the bait station and at least part of the passage. In some embodiments, the sidewall extends along the entire length of the passage. In some embodiments, at least a portion of the sidewall is vertical. In some embodiments, the passage is the only passage that the lid and the base if coupled together cooperate to define. In some embodiments, at least one of the base and the lid includes a sidewall defining an external perimeter of the bait station and at least part of the passage. In some embodiments, at least a portion of the sidewall is vertical. In some embodiments, the sidewall defines the entire length of the passage. In some embodiments, the entrance opening is disposed at the first end of the passage. In some embodiments, the bait is disposed at the second end of the passage. In some embodiments, at least a portion of the passage is curved. In some embodiments, the passage is U-shaped. In some embodiments, the passage include a first leg, a second leg, and a transition portion between the first leg and the second leg. In some embodiments, the first leg extends between the first end and the transition portion, the second leg extends between the second end and the transition portion, and the second leg is longer than the first leg. In some embodiments, the entrance opening is disposed in the first leg of the passage.

In some embodiments, at least one of the base and the lid includes a groove, and the other of the base and the lid includes a flange configured to extend into the groove if the lid is coupled to the base such that the base and the lid cooperate to define the channel. In some embodiments, the one of the lid and the base with a groove includes a plurality of ledges, and the other of the lid and the base with a flange includes a plurality of barbed projections configured to contact the plurality of ledges to resist separation of the lid and the base if the lid is coupled to the base such that the base and the lid cooperate to define the channel. In some embodiments, the lid and base are configured such that at least some of the barbed projections will extend through the groove if the lid and base are coupled together to cooperate to define the passage. In some embodiments, the lid is pivotally coupled to the base such that the lid can be pivoted relative to the base between an open position and a closed position in which the base and the lid cooperate to define the channel. In some embodiments, the lid is unitary with the base.

In some embodiments, the at least one of the lid and the base includes a plurality of barbed projections, the other of the lid and the base includes a plurality of ledges configured to contact the plurality of barbed projections to resist separation of the lid and the base if the lid and the base cooperate to define the passage. In some embodiments, a barb of each of the plurality of barbed projections faces away from the barbs of the others of the plurality of barbed projections. In some embodiments, at least two of the plurality of barbed projections are spaced apart such that if the two barbed projections contact the corresponding ledges, a single key will not simultaneously separate both of the two barbed projections from the corresponding ledges.

Some embodiments further comprise: bait disposed in the passage between the first end and the second end such that the bait is not visible through the entrance opening from outside the bait station.

Some embodiments of the present bait stations comprise: a base; and lid configured to be coupled to the base such that the base and the lid cooperate to define a single passage having a first end and a second end; here the passage has a centerline that is at least three times as long as the average width of the passage. In some embodiments, the centerline of the passage deviates from an axis. In some embodiments, at least a portion of the centerline of the passage is curved.

Some embodiments of the present bait stations comprise: a base; and a lid configured to be coupled to the base such that the base and the lid cooperate to define an elongated passage having a first end and a second end, and an entrance opening configured to permit a rodent to enter the passage; where at least one of the base and the lid includes a sidewall defining the length of the passage and an external perimeter of the bait station. In some embodiments, at least a portion of the sidewall is vertical.

Some embodiments of the present bait stations comprise: a base; and a lid configured to be coupled to the base such that the base and the lid cooperate to define an elongated passage having a first end and a second end, and an entrance opening configured to permit a rodent to enter the passage; where the passage includes a first leg, a second leg, and a transition portion between the first leg and the second leg, the first leg extends between the first end and the transition portion, the second leg extends between the second end and the transition portion, the second leg is longer than the first leg, and the entrance opening is in direct fluid communication with the first leg.

Some embodiments of the present bait stations comprise: a base; and a lid configured to be coupled to the base such that the base and the lid cooperate to define an elongated passage having a first end and a second end, and an entrance opening in fluid communication with the passage; where the passage include a first leg, a second leg, and a transition portion between the first leg and the second leg; and where the base has a first leg exterior portion and a second leg exterior portion that is spaced apart from the first leg exterior portion, the first leg exterior portion and the second leg exterior portion being at an angle of 0 to 20 degrees to each other. In some embodiments, the first exterior portion is vertically-oriented, and the second exterior portion is vertically-oriented. In some embodiments, the lid is coupled to the base in a closed configuration, and further comprising bait disposed in the passage. In some embodiments, the bait has a height of at least fifty percent (50%) of a height of the passage.

Some embodiments of the present methods comprise: disposing bait in an embodiment of any of the present bait stations. In some embodiments, the bait is at least one of: harmful to a rodent if ingested by the rodent; deadly to a rodent if ingested by the rodent; and/or positioned on a snap trap. Some embodiments further comprise: coupling the lid of the bait station to the base in a closed configuration. In some embodiments, the lid is coupled to the base such that the lid cannot be opened relative to the base without damaging the bait station.

Some embodiments of the present methods comprise: disposing an embodiment of the present bait stations on a surface. In some embodiments, the surface comprises at least a portion of a floor, the earth, a weight, or a weightable container.

Any embodiment of any of the present bait stations can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Details associated with the embodiments described above and others are presented below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The embodiments of the present bait stations and their components shown in the figures are drawn to scale.

FIG. 1 depicts a plan view of one of the present bait stations having a base and a lid, with the lid shown in both open (left) and closed (right) configurations relative to the base.

FIG. 2 depicts a side view of the bait station of FIG. 1, with the lid shown in both open (left) and closed (right) configurations relative to the base.

FIG. 3 depicts a first end view of the bait station of FIG. 1. The lid is again shown in an open configuration and a closed configuration.

FIG. 4 depicts a second end view of the of the bait station of FIG. 1. The lid is again shown in an open configuration and a closed configuration.

FIG. 5 depicts an upper perspective view of the bait station of FIG. 1, with the lid shown in both open (left) and closed (right) configurations relative to the base.

FIGS. 6 and 7 depict perspective views of the bait station of FIG. 1, with the lid in an open configuration relative to the base.

FIG. 8 depicts and upper perspective view of a base of a second embodiment of the present bait stations.

FIG. 9 depicts a side view of the base of FIG. 8.

FIG. 10 depicts a front view of the base of FIG. 8.

FIG. 11 depicts a top view of the base of FIG. 8.

FIG. 12 depicts a top view of a lid for use with the base of FIG. 8.

FIG. 13 depicts and upper perspective view of a base of a third embodiment of the present bait stations.

FIG. 14 depicts a side view of the base of FIG. 13.

FIG. 15 depicts a front view of the base of FIG. 13.

FIG. 16 depicts a top view of the base of FIG. 13.

FIG. 17 depicts a top view of a lid for use with the base of FIG. 13.

FIG. 18 depicts a perspective view of a base of a fourth embodiment of the present bait stations, shown with a bait block in the base.

FIG. 19 depicts a top view of the base of FIG. 18.

FIG. 20 depicts a side view of the base of FIG. 18.

FIG. 21 depicts a top view of a lid for use with the base of FIG. 18.

FIG. 22 depicts a side view of the lid of FIG. 21.

### DESCRIPTION OF ILLUSTRATIVE EMBODIMENTS

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a bait station that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps.

Further, a bait station, or a component of a bait station, that is configured in a certain way is configured in at least that way, but it can also be configured in other ways than those specifically described.

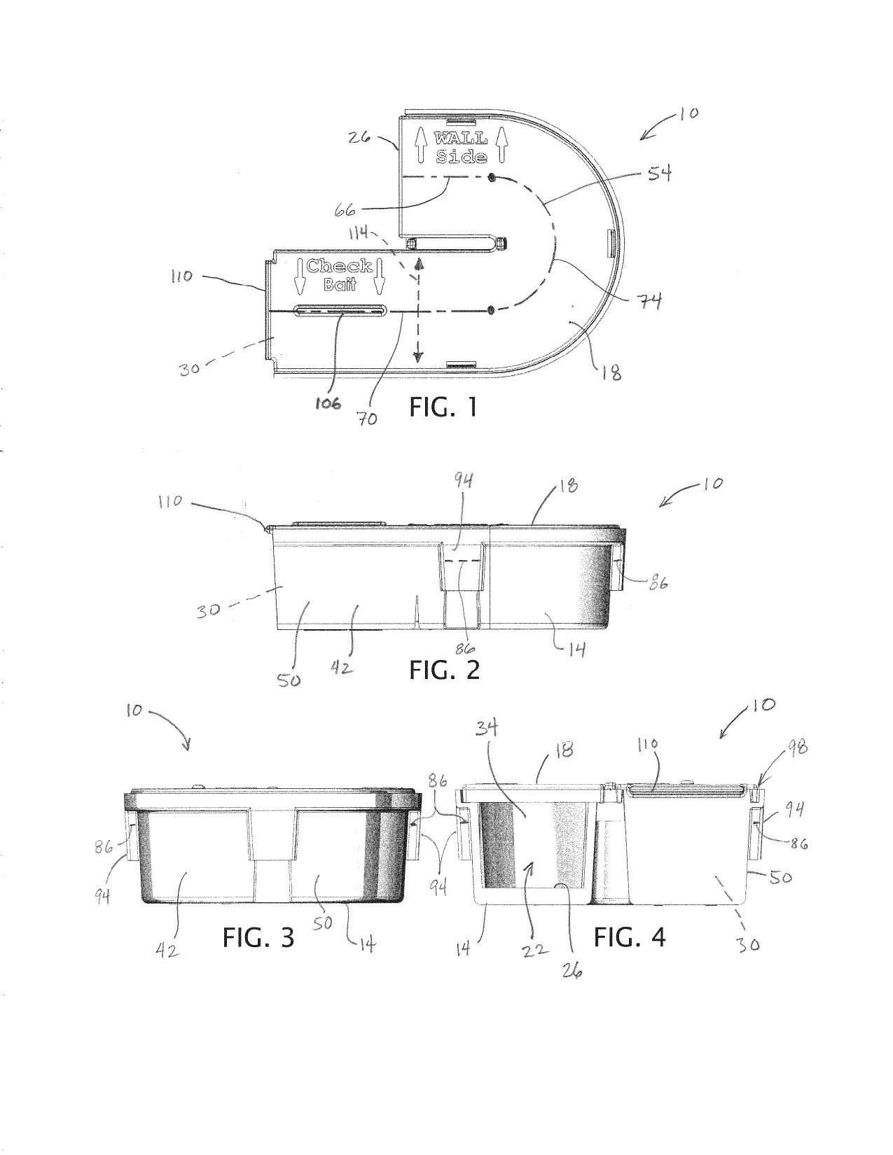

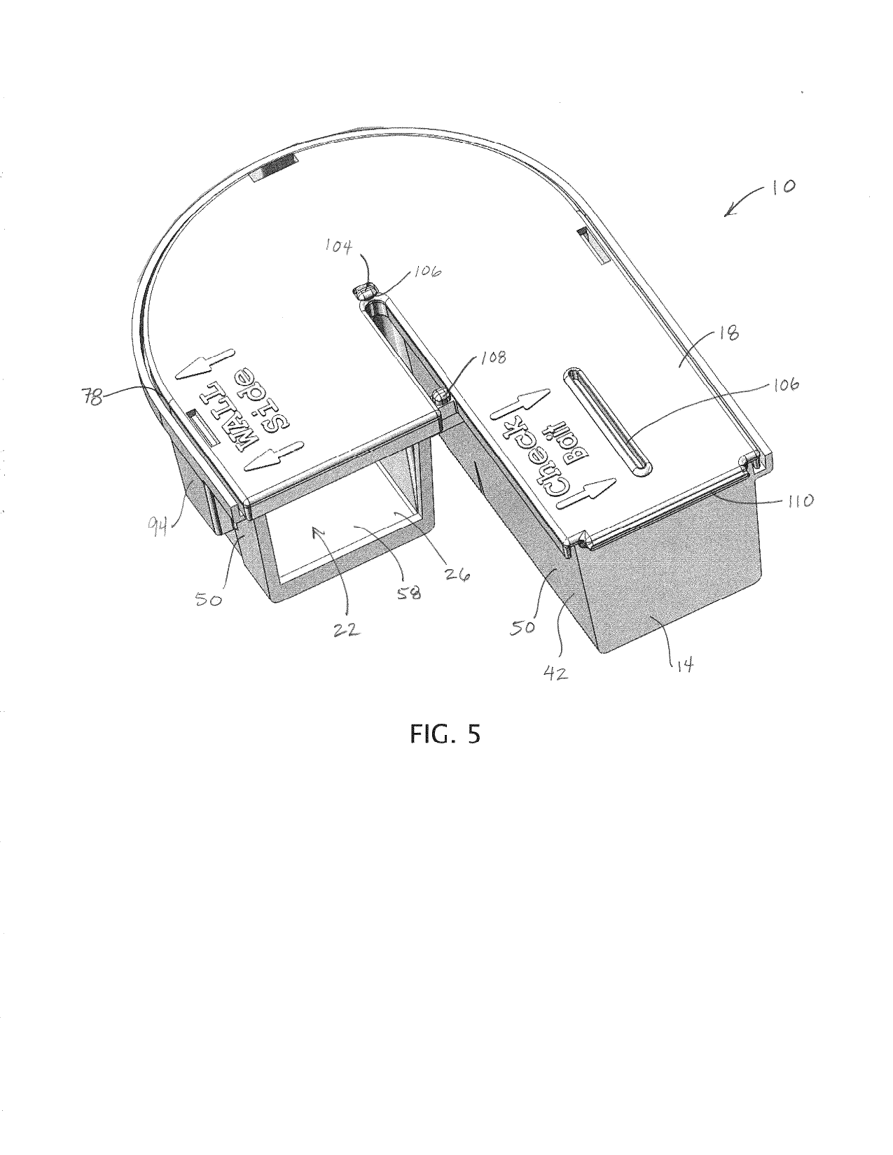

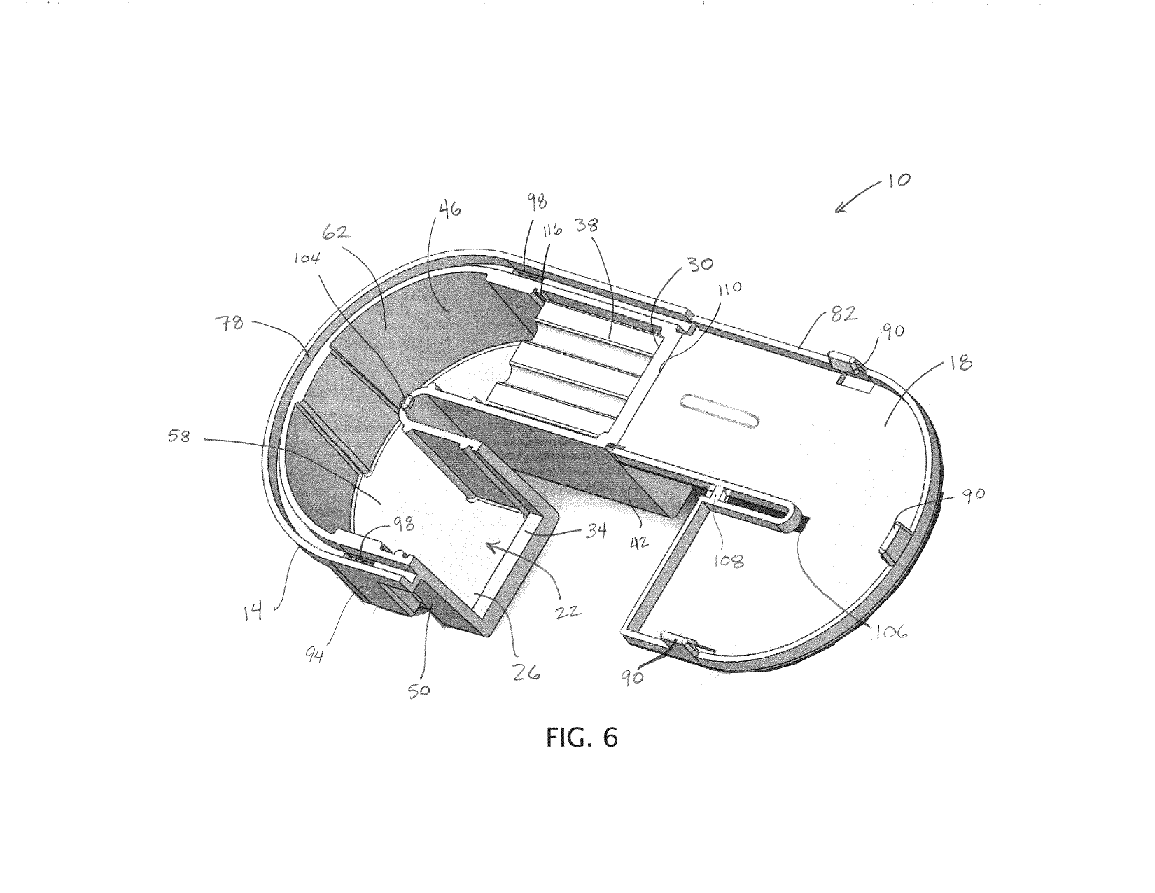

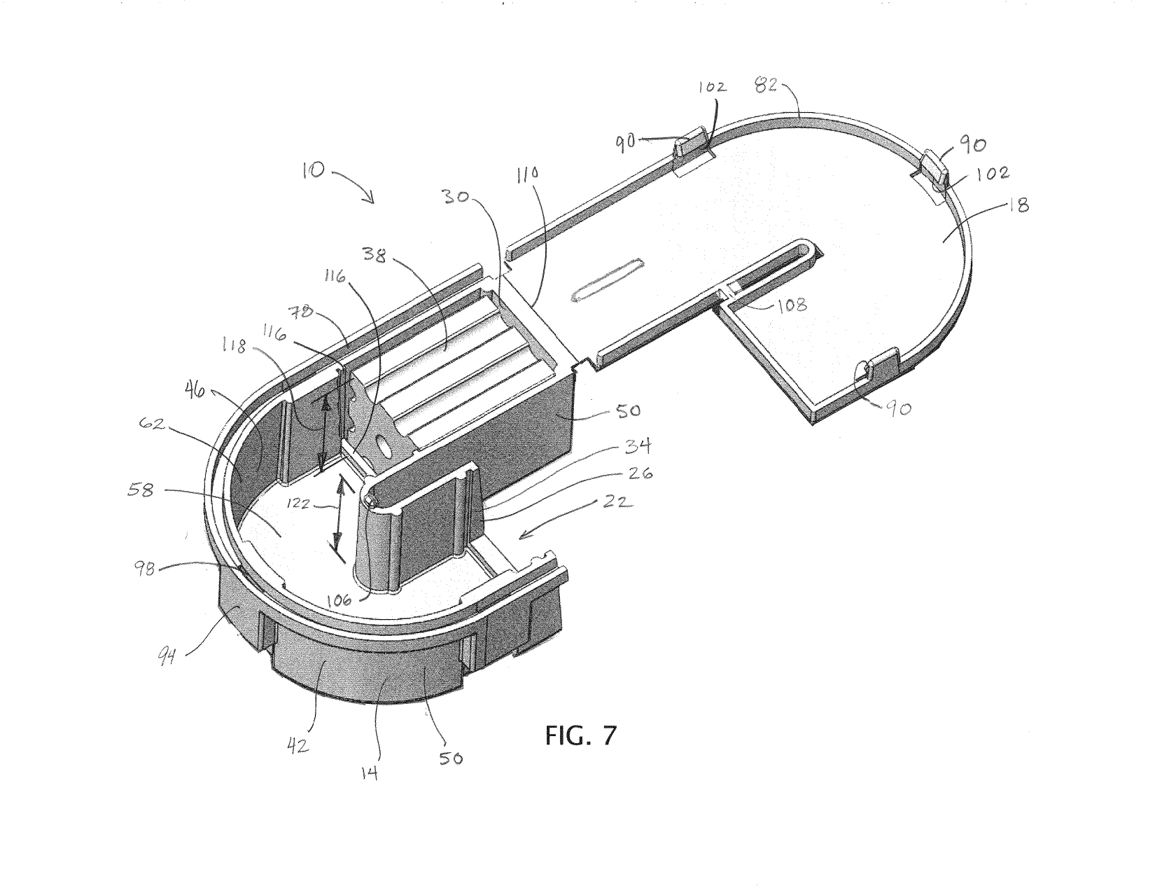

Referring now to the drawings, and more particularly to FIGS. 1-7, shown therein and designated by the reference numeral 10 is one embodiment of the present rodent bait stations. In the embodiment shown, station 10 comprises a base 14 and a lid 18. FIG. 1 depicts a top view of station 10; FIG. 2 depicts a side view of station 10; FIG. 3 depicts a first end view of station 10; FIG. 4 depicts a second end view of station 10; and FIGS. 5-7 depict various perspective views of station 10. For illustrative purposes, station 10 is shown in FIGS. 1-5 with lid 18 in both open and closed configurations; however, in the embodiment shown, station 10 includes only a single lid 18. For example, FIGS. 6 and 7 depict station 10 with lid 18 in only an open configuration.

In some embodiments, such as the embodiment shown, lid 18 is configured to be coupled to base 14 such that the base and the lid cooperate to define an elongated passage 22 (e.g., a single elongated passage 22, as in the embodiment shown) having a first end 26 and a second end 30. In the embodiment shown, the lid is configured to be coupled to the base such that the base and the lid also cooperate to define an entrance opening 34 configured to permit a rodent to enter passage 22 (and in fluid communication with passage 22). In other embodiments, opening 34 may be defined by only one of base 14 or lid 18.

In the embodiment shown, station 10 (and passage 22) is configured such that if lid 18 is coupled to base 14 in a closed configuration (e.g., as is shown in FIGS. 1-5), bait 38 can be disposed in the passage between first end 26 and second end 30 without being visible from outside the rodent bait station (e.g., through opening 34). For example, bait 38 can be disposed in a portion of passage 22 (e.g., at second end 30) that is closer to second end 30 than to first end 26 (e.g., such that no part of bait 38 is closer to first end 26 than to second end 30). Accordingly, in some embodiments, station 10 comprises bait (e.g., poisoned bait) 38 (e.g., in any suitable form, such as, for example, solid, granular, liquid, etc.). The bait may be characterized as bait designed to kill pests (e.g., rodents such as mice or rats). However, it should be understood that in other embodiments, station 10 can comprise any suitable loadable and/or reloadable pest-control device, such as, for example, an insect bait station. In some embodiments, station 10 comprises an aerosol container configured to dispense pest attractant and/or poison.

In some embodiments, station 10 is configured such that if lid 18 is coupled to base 14 in a closed configuration (as shown in FIGS. 1-5, and as opposed to the open configuration shown in FIGS. 6 and 7), opening 34 is the only entrance to passage 22 (e.g., for a rodent such as a mouse or rat). For example, in the embodiment shown, opening 34 is disposed at first end 26 of passage 22, and base 14 and lid 18 do not cooperate to define any openings between first end 26 and second end 30 of the passage.

In some embodiments, at least one of base 14 and lid 18 includes a sidewall 42 that defines an external perimeter of the rodent bait station and at least part of passage 22. For example, in the embodiment shown, an inner surface 46 of sidewall 42 defines at least part of passage 22 (e.g., extends along and defines the entire length of passage 22), and outer surface 50 of sidewall 42 defines an external perimeter of station 10 (e.g., the perimeter of a cross-section of station 10 taken in a plane parallel to lid 18 if lid 18 is in a closed configuration). In the embodiment shown, sidewall 42 extends along the entire length of the passage (taken along a centerline 54 extending along the center of passage 22 between first end 26 and second end 30), as illustrated in FIG. 1. In some embodiments, such as the embodiment shown, passage 22 is the only passage that lid 18 and base 14 (if coupled together) cooperate to define.

In some embodiments, at least a portion of sidewall 42 is vertical. For example, in the embodiment shown, sidewall 42 includes a bottom 58 that is horizontal when base 14 is disposed on a horizontal surface, and vertical and/or side portions 62 that are substantially vertical when base 14 is disposed on a horizontal surface. In some embodiments, the cross-sectional area (taken in a plane perpendicular to centerline 54) of passage 22 does not vary along the length of the passage (along centerline 54) by more than fifty percent (50%) relative to the smallest cross-sectional area of the passage. For example, in the embodiment shown, the cross-sectional area of the passage 22 does not vary by more than 20% relative to the smallest cross-sectional area of the passage (e.g., is substantially constant along centerline 54).

In some embodiments, centerline 54 of passage 22 deviates from an axis. For example, in some embodiments, at least a portion of (e.g., centerline 54 of) passage 22 is curved (e.g., is U-shaped and/or J-shaped). For example, in some embodiments, such as the embodiment shown, passage 22 include a first leg 66, a second leg 70, and a transition portion 74 between the first leg and the second leg. In the embodiment shown, first leg 66 extends between first end 26 and transition portion 74, second leg 70 extends between second end 30 and transition portion 74, and second leg 70 is longer than first leg 66. In the embodiment shown, opening 34 is disposed in (and in direct fluid communication with) first leg 66 of passage 22 (e.g., at first end 26). In the embodiment shown, base 14 is configured such that exterior surface 50 of a portion of sidewall 42 defining first leg 66 (a first leg exterior portion) is spaced apart from exterior surface 50 of a portion of sidewall 42 defining second leg 70 (a second leg exterior portion). In some embodiments, the first leg exterior portion and the second leg exterior portion are disposed at an angle of 0 to 20 degrees to each other, including any integer between 0 and 20 and all ranges between (and including) all such integers. For example, in the embodiment shown, the first leg exterior portion is substantially parallel (at an angle of substantially 0 degrees) to the second leg exterior portion. In the embodiment shown, the first leg exterior portion is substantially vertical, and the second leg exterior portion is substantially vertical.

In some embodiments, at least one of base 14 and lid 18 includes a groove 78, and the other of base 14 and lid 18 includes a flange 82 configured to extend into groove 78 if the lid is coupled to the base such that the base and the lid cooperate to define channel 22. For example, in the embodiment shown, lid 18 includes flange 82, and base 14 includes groove 78. In the embodiment shown, groove 78 extends along the outer peripheral edge of base 14 (between first end 26 and second end 30), but base 14 does not include a groove on the inner peripheral edge, as shown. In some embodiments, one of the lid and the base with a groove includes a plurality of ledges 86, and the other of the lid and the base with a flange includes a plurality of barbed projections 90 configured to contact ledges 86 to resist separation of the lid and the base if the lid is coupled to the base such that the base and the lid cooperate to define channel 22. For example, in the embodiment shown, base 14 includes a plurality of ledges 86, and lid 18 includes a plurality of barbed projections 90. For example, in the embodiment shown, base 14 includes a plurality of hollow protrusions 94 defining channels 98 (at least partially aligned with groove 78) within which ledges 86 are defined, such that barbed protrusions 90 can extend into channels 98 to contact ledges 86 to resist separation of lid 18 and base 14.′

In the embodiment shown, lid 14 and base 18 are configured (e.g. with hollow projections 94 and channels 98) such that at least some of barbed projections 90 will extend through groove 78 if the lid and base are coupled together to cooperate to define the passage. In the embodiment shown, a barb 102 of each of the plurality of barbed projections 90 is not parallel to at least one barb of the others of the plurality of barbed projections. For example, in the embodiment shown, lid 18 includes three barbed projections 90, each with a barb 102, that are configured such that each barb 102 is perpendicular to at least one other barb 90. In the embodiment shown, at least two of the plurality of barbed projections 90 are spaced apart such that if the two barbed projections contact the corresponding ledges 86, a single key will not simultaneously separate both of the two barbed projections from the corresponding ledges. For example, in the embodiment shown, barbed projections 90 are spaced apart such that a separate key, or a single key at different times, must be used to separate the barbed projections from the corresponding ledges (e.g., by extending the key through a key hole in the lid 18). In the embodiment shown, base 14 includes a barbed projection 104 configured to (e.g., extend through the lid and) engage a ledge 106 on the lid. As shown, a projection 104 can be disposed between first leg 66 and second leg 70 (e.g., substantially aligned in the middle of transition portion 74).

In the embodiment shown, lid 18 includes a bridge portion 108 extending between the portion of the lid that is configured to cover the first leg 66 and the portion of the lid that is configured to cover the second leg 70 (e.g., to resist deflection between these two portions of the lid, such as, for example, when the lid is coupled to or closed relative to the body). In the embodiment shown, station 10 is configured as a single-use station (e.g., is configured to be unopenable once lid 18 is closed relative to body 14). In some embodiments, glue or adhesive is added to barbed projections 90 and 104 prior to closing the lid such that the glue or adhesive will form a substantially permanent bond between the lid and the body (e.g., in such embodiments, barbs may be omitted from projections 90 and 104). In other embodiments, station 10 is configured with a bait cartridge or drawer at second end 30 of passage 22 (e.g., through the sidewall or bottom of housing 14, or through lid 18) such that bait 38 can be replaced when depleted, and such that bait cartridge or drawer is child-resistant (e.g., requires application of forces in multiple directions to remove the cartridge or open the drawer).

In the embodiment shown, lid 18 comprises a slot or opening 106 through which bait 38 can be viewed (e.g., to determine whether any of the bait is left, or has all been eaten or otherwise removed). Opening 106 may be omitted from other embodiments.

In some embodiments, lid 14 is pivotally coupled to base 18 such that the lid can be pivoted relative to the base between an open position (as shown in FIGS. 6-7) and a closed position (as shown in FIGS. 1-5) in which the base and the lid cooperate to define channel 22. For example, in the embodiment shown, lid 18 is unitary with base 14 (e.g., the lid and the base are formed as a single piece of material), such that station 10 comprises a hinge portion 110 that is unitary with both of the base and the lid.

In the embodiment shown, station 10 is configured such that centerline 54 is at least three times as long as a (e.g., interior) width 114 (perpendicular to centerline 54) of passage 22 (e.g., the average width of the passage). For example, in the embodiment shown, passage 22 has a substantially constant width 114, and centerline 54 has a length that is greater than three times width 114. In the embodiment shown, body 14 includes a ridge 116 extending from bottom 58 and vertical portion 62 of sidewall 42, such that a distance between opposing side portions of ridge 116 is smaller than the width of bait 38, and such that a distance between bottom portion of ridge 116 and lid 18 (when lid 18 is closed) is smaller than the height of bait 38 (e.g., such that ridge 116 resists movement of bait 38 away from second end 30. In some embodiments, bait 38 is affixed to base 14 with glue or adhesive.

In some embodiments, lid 18 is coupled to base 14 in a closed configuration, and/or bait 38 disposed in passage 22. In some embodiments, bait 38 has a height 118 of at least fifty percent (50%) of a height 122 of the passage. For example, in the embodiment shown, height 118 of bait 38 is substantially equal to height 122 of channel 22. In some embodiments, station 10 is configured to fit within a rectangular cylinder with a volume of less than 10 cubic inches (in³), 8 in³, 6 in³, or less.

In the embodiment shown, station 10 (e.g., at least one of and/or both of base 14 and lid 18) may comprise plastic. For example, in some embodiments, base 14 and/or lid 18 comprises a plastic selected from the group consisting of: polypropylene (PP), polystyrene (PS), high impact polystyrene (HIPS), acrylonitrile butadiene styrene (ABS), polyethylene terephthalate (PET), polyvinyl chloride (PVC), polycarbonate (PC), polyethylene (PE), and polycarbonate/acrylonitrile butadiene styrene (PC/ABS), polycarbonate polybutylene terephthalate (PBT), acrylonitrile styrene acrylate (ASA), polyurethanes, nylon (often referred to as polyamide (PA)), combinations thereof, and/or other plastics or polymers. In other embodiments, station 10 (e.g., at least one of and/or both of base 14 and lid 18) comprises a non-plastic material, such as, for example, a metal (e.g., steel, iron, aluminum, copper, brass, or the like), fiberglass, carbon fiber, synthetic materials, and other suitably durable or rigid materials.

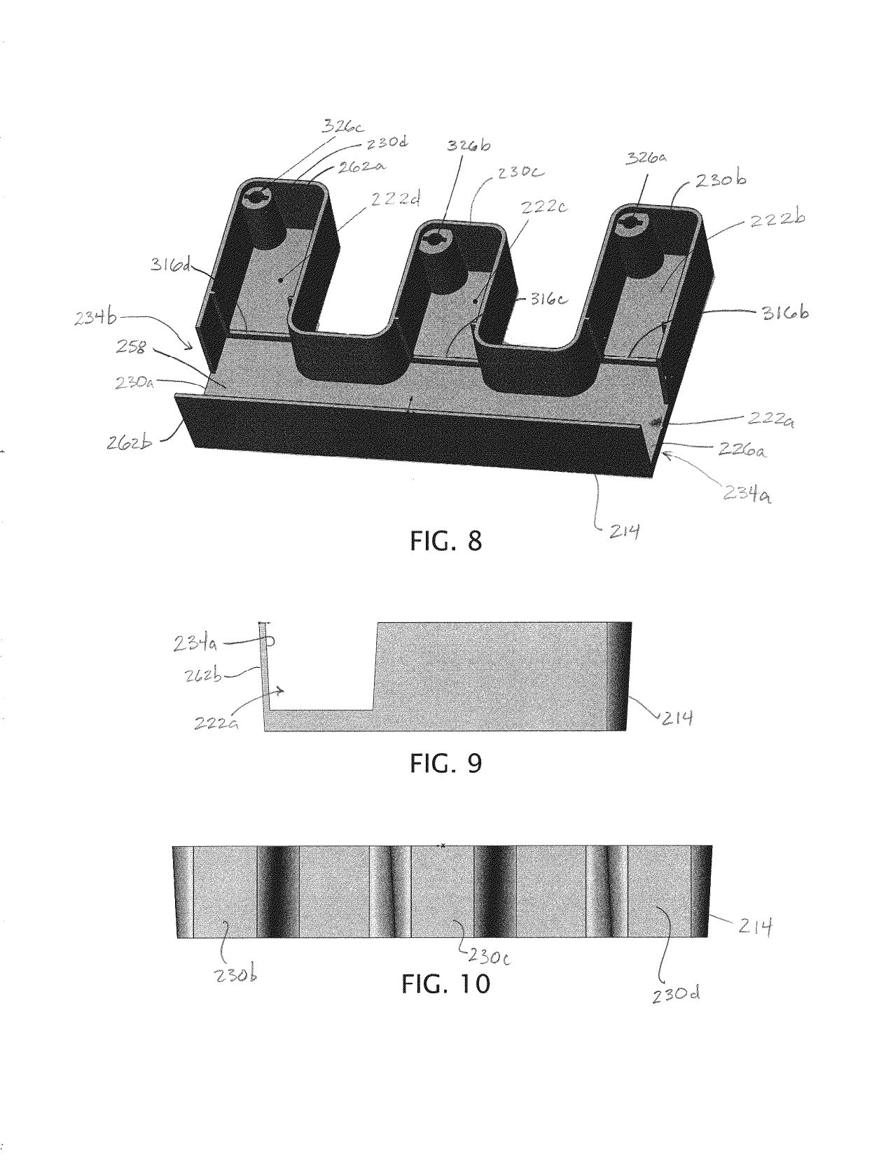

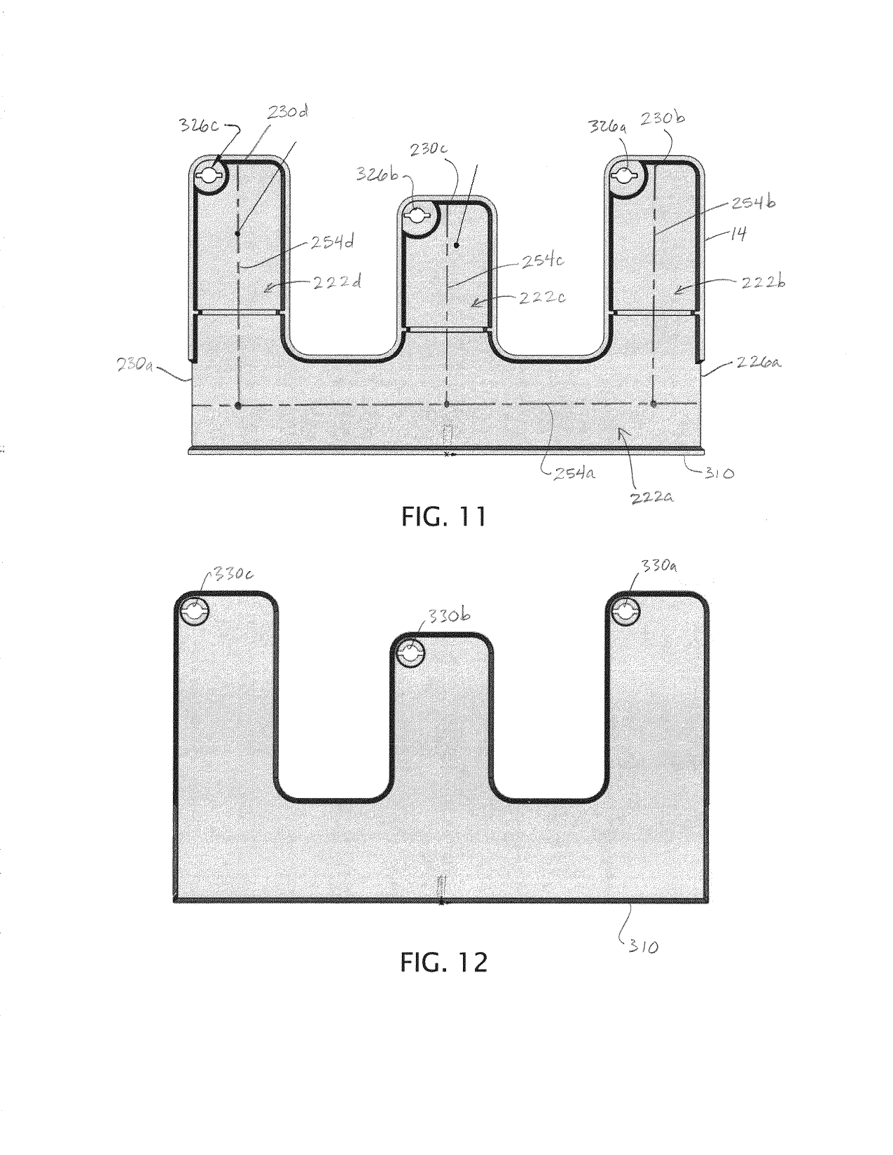

Referring now to FIGS. 8-12, shown therein is a base 214 for a second, E-shaped embodiment of the present bait stations, and a lid 218 for the second embodiment. Base 214 is substantially similar in many respects to base 14, and base 214 can include any one or more of the features described above with reference to base 14 except as described here or precluded by the differences in the second embodiment. In the embodiment shown, base 214 and lid 218 are configured to cooperate to define a primary passage 222a extending between a first end 226a and a second end 230a (as indicated by centerline 254a, and a plurality of secondary passages 222b, 222c, 222d extending from primary passage 222a to distal ends 230b, 230c, and 230d, respectively (as indicated by respective centerlines 254b, 254c, 254d). In the embodiment shown, secondary passages 222b, 222c, 222d are each substantially perpendicular to primary passage portion 222a. In the embodiment shown, body 214 includes ridges 316b, 316c, and 316d in passages 222b, 222c, and 222d, respectively. In the embodiment shown, passage 222c is configured to receive bait block 38 (e.g., such that ridge 316c will resist movement of the bait block away from distal end 230b). In the embodiment shown, passages 222b and 222d are configured to receive a glue pad (e.g., on bottom portion 258 of sidewall 342 between ridge 316b or 316d, and distal end 230b or 230d, respectively). In some embodiments, an adhesive can be disposed directly on bottom portion 258 of sidewall 242 between ridge 316b or 316d and distal end 230b or 230d, respectively.

In the embodiment shown, base 214 and lid 218 are configured to cooperate to define a first entrance opening 234a at first end 226a, and a second entrance openings 234b at second end 230a, with each of the entrance openings configured to permit a rodent to enter passage 222a. In the embodiment shown, passage 222a extends between first opening 234a and second opening 234b, and passages 222b, 222c, 222d extend outward from passage 222a between first opening 234a and second opening 234b. In the embodiment shown, base 214 is configured such that bait (e.g., bait block 38) can be disposed in passage 222c such that the bait is not visible through either opening 234a or 234b from outside the bait station (e.g., when lid 218 is closed relative to base 214), can be disposed in passage 222b such that the bait is not visible through opening 234b from outside the bait station, and/or can be disposed in passage 222d such that the bait is not visible through opening 234a from outside the station. In the embodiment shown, side (and/or substantially vertical) portions 262a and 262b, and bottom portion 258, of sidewall 242 each defines at least a portion of at least one of the passages (222a, 222b, 222c, 222d) and at least a portion of an outer perimeter of the bait station.

In some embodiments, lid 218 can be unitary with base 214 along a hinge portion 310 along which lid 218 can pivot relative to base 214. In other embodiments, any suitable hinge structure can be used, or lid 218 can be configured to be independent of base 214 until the two are coupled together (e.g., via glue, adhesive, etc.). In the embodiment shown, base 214 and lid 218 each include a plurality of slotted openings 326a, 326b, 326c, and 330a, 330b, 330c, respectively, that are configured such that if the lid is closed relative to the base, fasteners (not shown, but for example, screws, rivets, key-type fasteners with a shaft and lateral projections extending outward from the shaft, or any other suitable fastener structure) can be inserted through pairs of slotted openings (326a and 330b, 326b and 330b, 326c and 330c) and turned such that the fasteners resist separation of the lid and the base. In other embodiments, lid and base can include a plurality of barbed projections (e.g., similar to barbed projections 90, described above) and corresponding ledges (e.g., similar to ledges 86, described above).

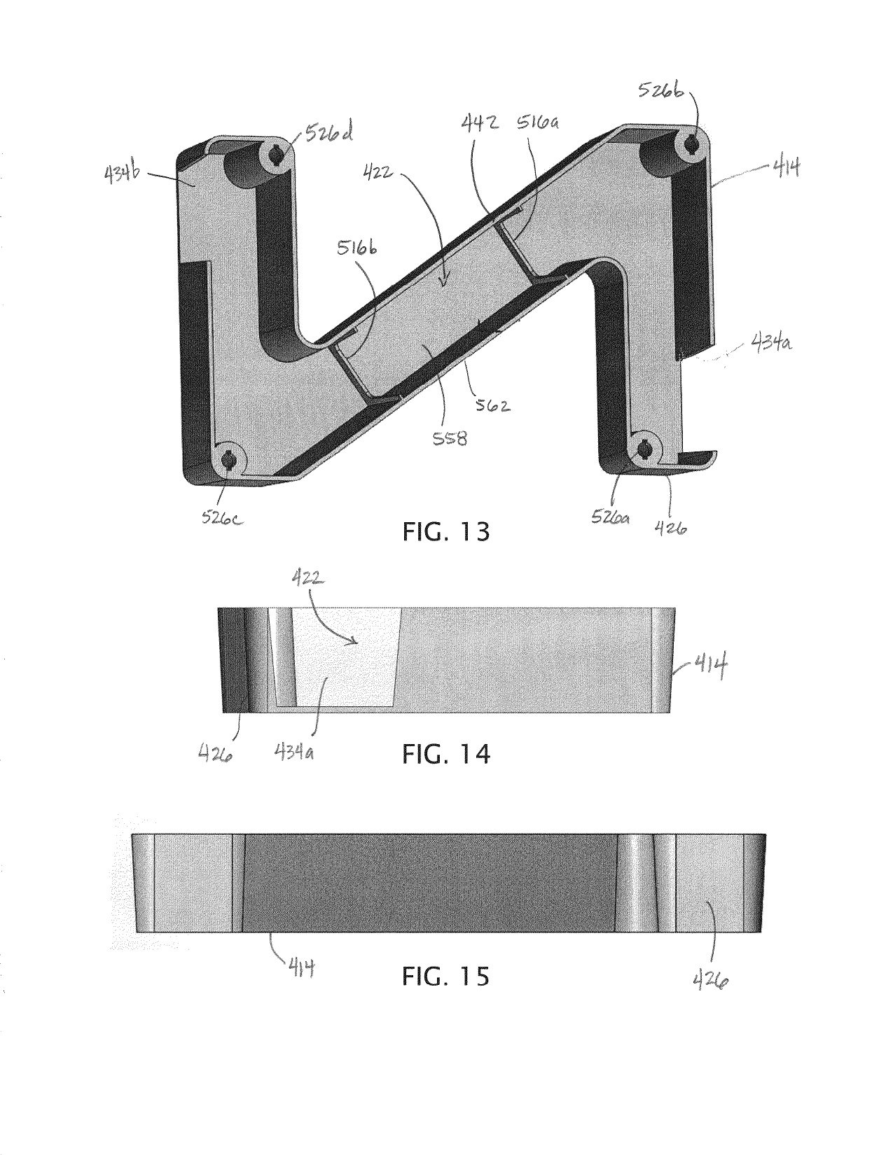

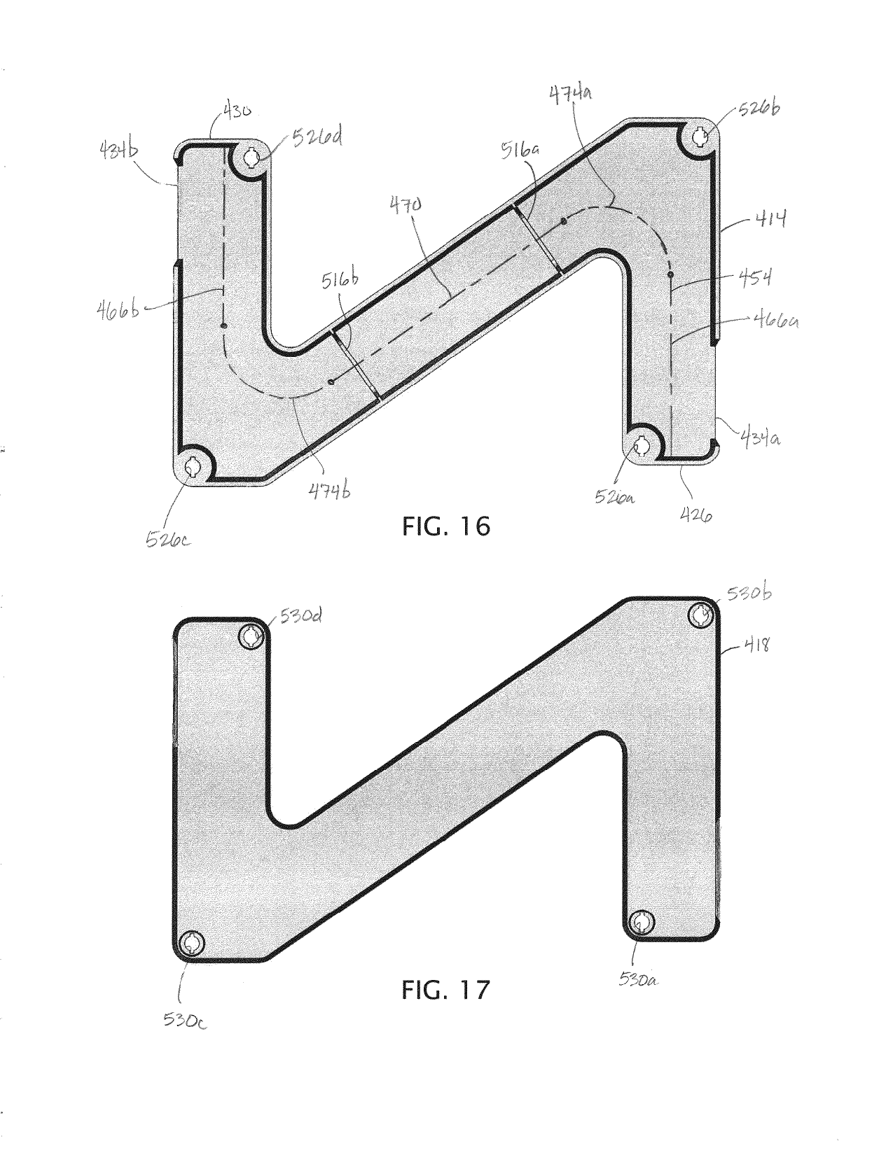

Referring now to FIGS. 13-17, shown therein is a base 414 for a third, Z-shaped embodiment of the present bait stations, and a lid 418 for the third embodiment. Base 414 is substantially similar in many respects to base 14, and base 414 can include any one or more of the features described above with reference to base 14 except as described here or precluded by the differences in the third embodiment. In the embodiment shown, base 414 and lid 418 are configured to cooperate to define a passage 422 extending between a first end 426 and a second end 430 (as indicated by centerline 454). In the embodiment shown, passage 422 includes a first outer leg 466a, a second outer leg 466b, a third or inner leg 470, a first transition portions 474a (between first outer leg 466a and inner leg 470), and a second transition portion 474b (between second outer leg 466b and inner leg 470). In the embodiment shown, first and second outer legs 466a and 466b are of substantially the same length, and third or inner leg 470 has a length that is greater than the length of the first and second outer legs. In the embodiment shown, outer legs 466a and 466b are each angularly disposed relative to inner leg 470 (e.g., are disposed at an angle of between 15 and 85 degrees, such as between 30 and 60 degrees, relative to inner leg 470). In the embodiment shown, body 414 includes ridges 516a and 516b in passages 422 (e.g., inner leg 470). In the embodiment shown, passage 422 is configured to receive bait block 38 (e.g., such that ridges 516a and 516b will resist movement of the bait block toward respective outer legs 466a and 466b, respectively.

In the embodiment shown, base 414 and lid 418 are configured to cooperate to define a first entrance opening 434a at (or adjacent, as shown) first end 426, and a second entrance openings 434b at (or adjacent, as shown) second end 430, with each of the entrance openings configured to permit a rodent to enter passage 422. In the embodiment shown, passage 422 extends between first opening 434a and second opening 434b. In the embodiment shown, the longitudinal axes of first and second outer legs 466a and 466b, respectively, do not extend through entrance openings 434a and 434b (the entrance openings are formed in the sides of the respective legs of channel 422 instead of in the ends). In the embodiment shown, base 414 is configured such that bait (e.g., bait block 38) can be disposed in passage 422 such that the bait is not visible through either opening 434a or 434b from outside the bait station (e.g., when lid 418 is closed relative to base 414). In the embodiment shown, side (and/or substantially vertical) portion 462, and bottom portion 458, of sidewall 442 each defines at least a portion of the passage and at least a portion of an outer perimeter of the bait station.

In some embodiments, lid 418 can be unitary with base 414 along a hinge portion (similar to 110 or 310) along which lid 418 can pivot relative to base 414. In other embodiments, any suitable hinge structure can be used, or lid 418 can be configured to be independent of base 414 until the two are coupled together (e.g., via glue, adhesive, etc.). In the embodiment shown, base 414 and lid 418 each include a plurality of slotted openings 526a, 526b, 526c, 526d and 530a, 530b, 530c, 530d, respectively, that are configured such that if the lid is closed relative to the base, fasteners (not shown, but for example, screws, rivets, key-type fasteners with a shaft and lateral projections extending outward from the shaft, or any other suitable fastener structure) can be inserted through pairs of slotted openings (526a and 530b, 526b and 530b, 526c and 530c, 526d and 530d) and turned such that the fasteners resist separation of the lid and the base. In other embodiments, lid and base can include a plurality of barbed projections (e.g., similar to barbed projections 90, described above) and corresponding ledges (e.g., similar to ledges 86, described above).

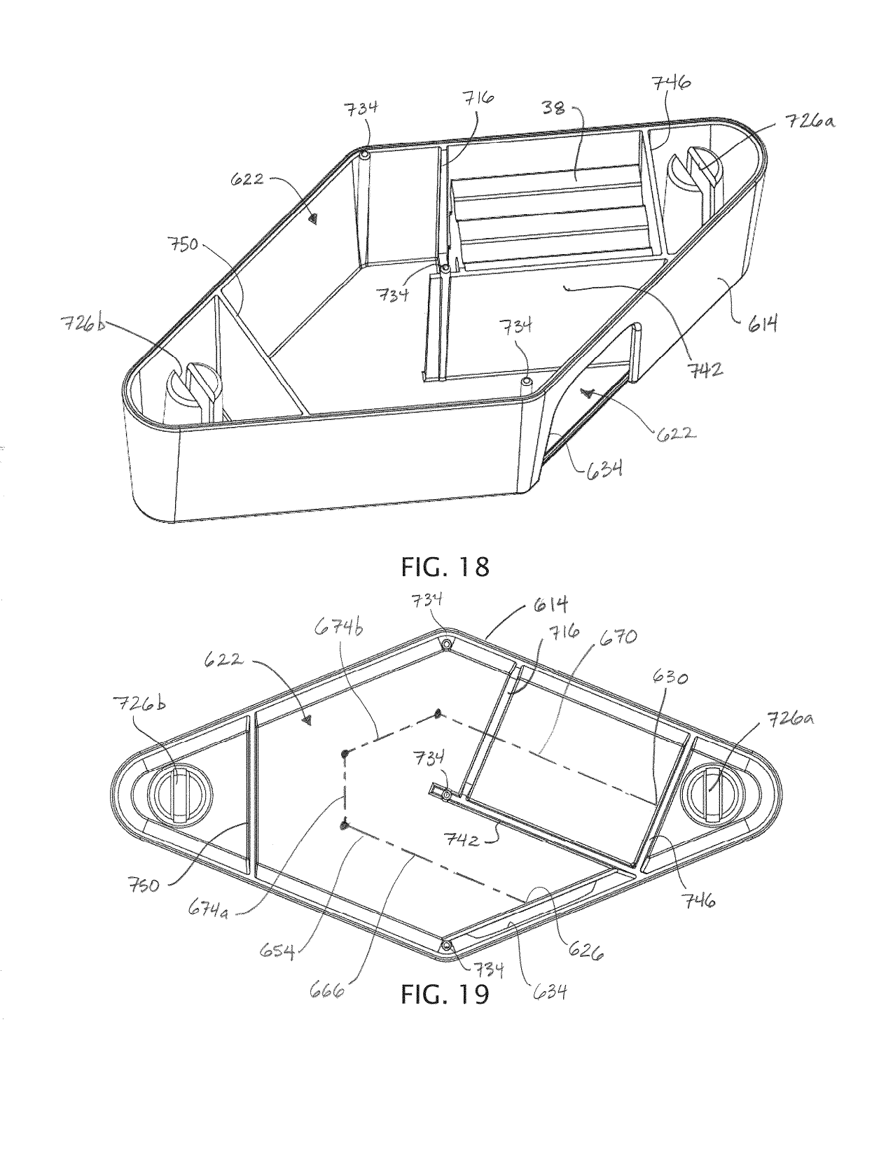

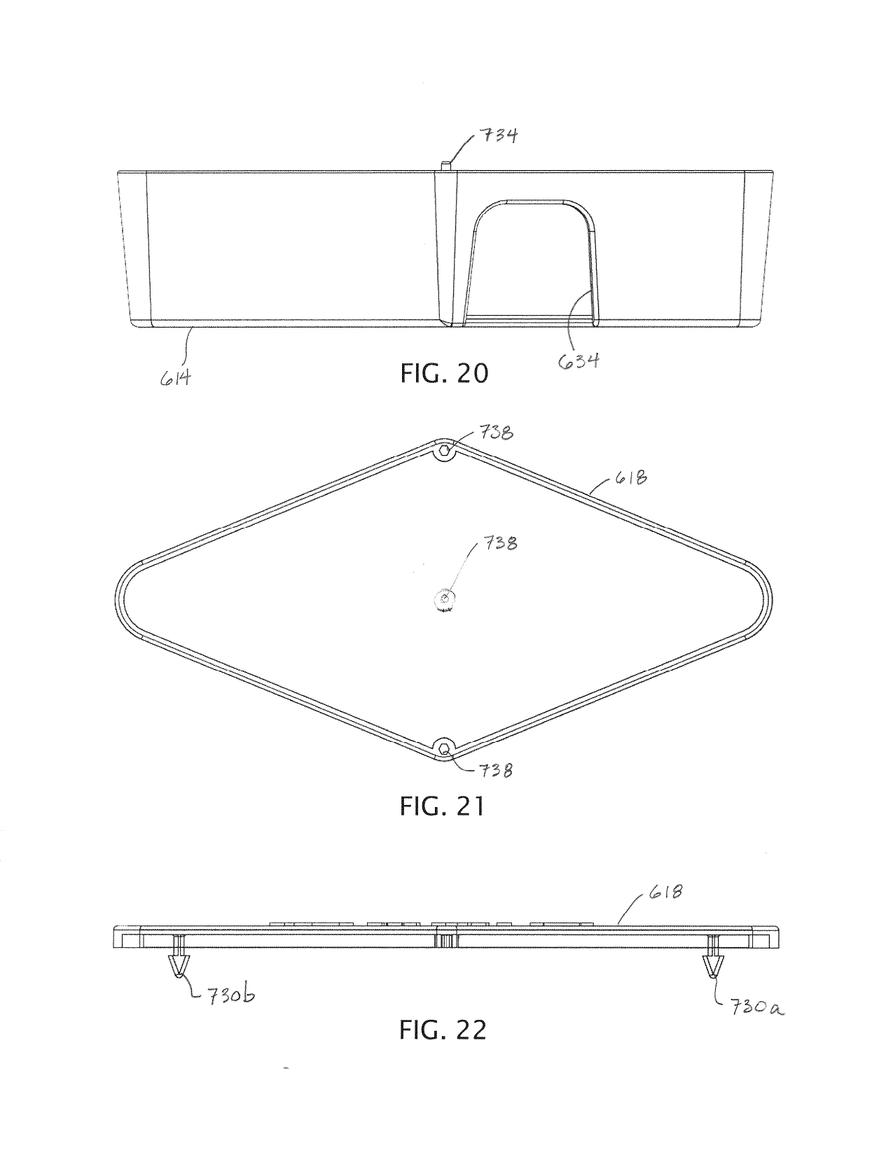

Referring now to FIGS. 18-22, shown therein is a base 614 for a fourth, diamond-shaped embodiment of the present bait stations, and a lid 618 for the fourth embodiment. Base 614 is substantially similar in some respects to base 14, and base 614 can include any one or more of the features described above with reference to base 14 except as described here or precluded by the differences in the fourth embodiment. In the embodiment shown, base 614 and lid 618 are configured to cooperate to define a passage 622 extending between a first end 626 and a second end 630 (as indicated by line 654 that approximates the centerline of the passage). In the embodiment shown, passage 622 includes a first leg 666, a second leg 670, a transition portion including a first segment 674a and a second segment 674b between first and second legs 666 and 670. In the embodiment shown, first leg 666 and second leg 670 are substantially parallel. In the embodiment shown, body 614 includes a ridges 716 in passage 622 (e.g., in first leg 666). In the embodiment shown, passage 622 is configured to receive bait block 38 (e.g., such that ridge 716 will resist movement of the bait block away from second end 630).

In some embodiments, lid 618 can be unitary with base 614 along a hinge portion (similar to 110 or 310) along which lid 618 can pivot relative to base 614 (e.g., a living hinge). In other embodiments, any suitable hinge structure can be used, or lid 618 can be configured to be independent of base 614 until the two are coupled together (e.g., via glue, adhesive, etc.). In the embodiment shown, base 614 includes two slotted openings 726a and 726b, and lid 618 includes two barbed projections 730a and 730b configured to extend into slotted openings 726a and 726b to hold lid 618 in substantially fixed relation to base 614. In some embodiments, the barbed projections and slotted openings are configured such that if lid 618 is coupled to base 614, lid 618 is not removable from base (e.g., is substantially prevented from being removed from the base without damaging at least one of the lid and the base). In other embodiments, the lid can be coupled to the base with any suitable structure or component. In the embodiment shown, base 614 includes projections 734 spaced apart from slotted openings 726a and 726b, and lid 618 includes openings 738 configured to receive projections 738 if lid 618 is coupled to base 614 (e.g., to further stabilize lid 618 relative to base 614).

In the embodiment shown, channel 622 includes an entrance opening 634 at (or adjacent, as shown) first end 626 that is configured to permit a rodent to enter passage 622. In the embodiment shown, passage 622 extends between first opening 634 (and first end 626) and second end 630. In the embodiment shown, base 614 is configured such that bait (e.g., bait block 38) can be disposed in passage 622 (e.g., at or near second end 630) such that the bait is not visible through opening 634 from outside the bait station (e.g., when lid 618 is closed relative to base 614); in the depicted embodiment, interior wall 742 contributes to such configuration. In the embodiment shown, side (and/or substantially vertical) portion 662, and bottom portion 658, of sidewall 642 each defines at least a portion of the passage and at least a portion of an outer perimeter of the bait station. In the embodiment shown, the base and lid cooperate to define a single passage 622. The embodiment of FIGS. 18-22 differs from the foregoing embodiments in that base 614 also includes an interior wall 742 that divides first leg 666 and second leg 670, and interior walls 746 and 750 that divide passage 622 from the portions of base 614 that include slotted openings 726a and 726b. In some embodiments, lid 618 includes a slot or opening 706 (e.g., through which bait 38 can be viewed).

The above specification and examples provide a complete description of the structure and use of exemplary embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the present devices are not intended to be limited to the particular forms disclosed. Rather, they include all modifications and alternatives falling within the scope of the claims, and embodiments other than the one shown may include some or all of the features of the depicted embodiment. For example, components may be combined as a unitary structure (e.g., base 14 and lid 18), and/or connections may be substituted (e.g., threads may be substituted with press-fittings or welds). Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A bait station comprising:
a base; and
a lid configured to be coupled to the base such that the base and the lid cooperate to define an elongated passage having a first end and a second end, and an entrance opening configured to permit a rodent to enter the passage;
where the station is configured such that if the lid is coupled to the base in a closed configuration, bait can be disposed in the passage between the first end and the second end without being visible through the entrance opening from outside the bait station.

2. The bait station of claim 1, where if the lid is coupled to the base in a closed configuration, the entrance opening is the only opening through which a rodent can enter the passage.

3. The bait station of claim 1, where the entrance opening is disposed at the first end of the passage, and the base and the lid do not cooperate to define any other openings between the first end and the second end of the passage.

4. (canceled)

5. The bait station of claim 1, where at least one of the base and the lid includes a sidewall defining an external perimeter of the bait station and at least part of the passage.

6-7. (canceled)

8. The bait station of claim 1, where the passage is the only passage that the lid and the base if coupled together cooperate to define.

9. The bait station of claim 8, where at least one of the base and the lid includes a sidewall defining an external perimeter of the bait station and at least part of the passage.

10-13. (canceled)

14. The bait station of claim 1, where at least a portion of the passage is curved.

15. The bait station of claim 1, where the passage is U-shaped.

16-18. (canceled)

19. The bait station of claim 1, where at least one of the base and the lid includes a groove, and the other of the base and the lid includes a flange configured to extend into the groove if the lid is coupled to the base such that the base and the lid cooperate to define the channel.

20-21. (canceled)

22. The bait station of claim 1, where the lid is pivotally coupled to the base such that the lid can be pivoted relative to the base between an open position and a closed position in which the base and the lid cooperate to define the channel.

23. (canceled)

24. The bait station of claim 1, where the at least one of the lid and the base includes a plurality of barbed projections, the other of the lid and the base includes a plurality of ledges configured to contact the plurality of barbed projections to resist separation of the lid and the base if the lid and the base cooperate to define the passage.

25. (canceled)

26. The bait station of claim 24, where at least two of the plurality of barbed projections are spaced apart such that if the two barbed projections contact the corresponding ledges, a single key will not simultaneously separate both of the two barbed projections from the corresponding ledges.

27. The bait station of claim 1, further comprising:
bait disposed in the passage between the first end and the second end such that the bait is not visible through the entrance opening from outside the bait station.

28-33. (canceled)

34. A bait station comprising:
a base; and
a lid configured to be coupled to the base such that the base and the lid cooperate to define an elongated passage having a first end and a second end, and an entrance opening in fluid communication with the passage;
where the passage include a first leg, a second leg, and a transition portion between the first leg and the second leg;
where the base has a first leg exterior portion and a second leg exterior portion that is spaced apart from the first leg exterior portion, the first leg exterior portion and the second leg exterior portion being at an angle of 0 to 20 degrees to each other.

35. The bait station of claim 34, where the first exterior portion is vertically-oriented, and the second exterior portion is vertically-oriented.

36. (canceled)

37. (canceled)

38. A method comprising:
disposing bait in a bait station of claim 1.

39. The method of claim 38, where the bait is at least one of: harmful to a rodent if ingested by the rodent; deadly to a rodent if ingested by the rodent; and/or positioned on a snap trap.

40. The method of claim 38, further comprising:
coupling the lid of the bait station to the base in a closed configuration.

41. The method of claim 40, where the lid is coupled to the base such that the lid cannot be opened relative to the base without damaging the bait station.

42. The method of claim 38, further comprising:
disposing the bait station on a surface.

43-44. (canceled)
